(19) United States
(12) Patent Application Publication
(10) Pub. No.: US 2014/0099462 A1
(43) Pub. Date: Apr. 10, 2014

(54) SEAMING PROCESS FOR REDUCING WEAK OR OPEN SEAMS AND BEADS IN A TDO SHRINK FILM TUBE

(71) Applicant: Fort Dearborn Company, LLC, Elk Grove, IL (US)

(72) Inventors: Nareshwar SWAROOP, Elk Grove, IL (US); Daryl MADAUS, Elk Grove, IL (US)

(73) Assignee: FORT DEARBORN COMPANY, LLC, Elk Grove, IL (US)

(21) Appl. No.: 14/016,714

(22) Filed: Sep. 3, 2013

Related U.S. Application Data
(60) Provisional application No. 61/710,457, filed on Oct. 5, 2012.

(51) Int. Cl. B29D 23/00

(52) U.S. Cl. CPC B29D 23/00
USPC 428/36.9; 156/217; 156/357

(57) ABSTRACT

An embodiment of the invention provides an improvement to the seaming process used in forming sleeves of TDO shrink film, which provides the benefit of reducing the incidence of open or weak seams in the TDO shrink film sleeve. Another embodiment of this invention provides a device used to improve the seaming equipment. Another embodiment of this invention provides an improvement in consistency of the seam lip quality.

This application claims priority to U.S. provisional application 61/710,457, filed Oct. 5, 2012, the contents of which are incorporated by reference in its entirety.

### BACKGROUND OF THE INVENTION

Transverse direction orientated (TDO) shrink films are often formed into sleeves or tubes that are placed over a container and then shrunk to fit in order to hold the label or to provide tamper resistant packaging around the cap or lid of the container.

TDO shrink film sleeves are usually produced from a flat piece of TDO shrink film (which may be printed or not printed) that is then formed into a tube after a seaming solvent is applied to one edge of the film and the two edges are brought together and bonded. The currently available seaming equipment from original equipment manufacturers (OEMs) provides one fluid dispenser for applying a seaming solvent to the TDO shrink film. However, with this design, if the solvent deposition is uneven (e.g. fails to deliver the right amount of solvent along the continuous length of the seam) the resulting seam can be weak. Or, if the solvent deposition was spotty and actually skipped areas, the resulting TDO shrink film sleeve will have an open (un-bonded) seam area. These weak or open seam defects in the sleeve lead to manufacturing issues later downstream when the faulty TDO shrink film sleeve is opened, cut, placed over the intended item/container, and then shrunk by conveying through a heat tunnel.

### SUMMARY OF THE INVENTION

Embodiments of the invention relate to processes for producing a flat-folded form of a TDO shrink film tube, which may be printed or not printed. In certain embodiments there are at least two independent depositions of solvent that are preferably deposited in substantially continuous depositions that are substantially superimposed on each other and are in substantially the same footprint of the solvent area. At least two independent depositions of solvent are applied in a substantially continuous stream from at least two independent fluid dispensers. In certain embodiments there are at least two independent depositions of solvent that are deposited in substantially continuous depositions that are deposited in the same footprint of the solvent area. In certain aspects, the two independent depositions are not substantially superimposed on each other but are instead deposited side-by-side but still in the same footprint of the solvent area.

In certain embodiments there are at least two different solvent reservoirs and two different delivery-train systems. In certain embodiments there is also an observation step where an observation component observes the solvent deposition and can relay information about the deposition so that the fluid dispenser can be re-positioned to improve the deposition. Improved deposition of the solvent includes sufficiency of the volume of the solvent and accuracy of the placement of the solvent.

Embodiments of the invention include a flat-folded form of a TDO shrink film tube formed by the processes described herein.

Embodiments of the invention also include devices for applying two independent depositions of solvent, wherein the two independent depositions of solvent are deposited in substantially continuous depositions that are substantially superimposed, not substantially superimposed or not superimposed on each other, but are in substantially the same footprint. In certain embodiments the device includes a first and a second fluid dispenser to apply the two independent depositions of solvent.

### BRIEF DESCRIPTION OF THE DRAWINGS

FIG. 1 provides a figure showing various nomenclature and terminology used in the TDO shrink film industry and throughout the application.

FIG. 2 shows a depiction of two fluid dispensers for applying two independent depositions of solvent to a solvent area on TDO shrink film. The figure shows a separate fluid dispenser controller and a separate fluid reservoir for each independent fluid dispenser. The fluid dispenser controller may be manual or automatic.

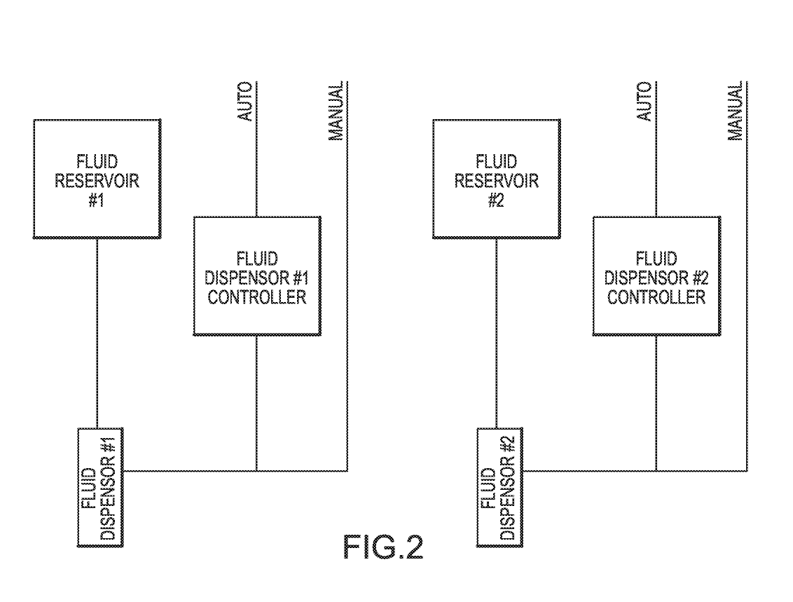

FIG. 3a shows an exemplary configuration of two independent fluid dispensers. Fluid dispenser 2 is depicted as a felt tip that can reach around the edge of the film. The figure depicts the felt tip depositing the seaming solvent to the bottom side of one outer edge of the TDO shrink film. Fluid dispenser 1 is depicted as a dispensing needle applying the seaming solvent to the top side of the other outer edge of the TDO shrink film.

FIG. 3b shows a depiction of two independent applications of seaming solvent in the solvent area, with each deposition on substantially the same footprint (the footprint being the solvent area). This figure depicts the first deposition from fluid dispenser 1 having a thinner deposition stream than the second deposition stream from fluid dispenser 2. This scenario may be produced if the first fluid dispenser is a dispensing needle and the second fluid dispenser is a felt tip, for example. The second deposition is shown as having a wider deposition stream. The figure shows that the second wider deposition stream is deposited so that it is substantially superimposed over the first deposition stream.

FIG. 4 provides an exemplary general overview of TDO shrink film seaming machinery. The figure shows the TDO shrink film being unwound and directed to the fluid application area where the seaming solvents will be deposited and then the film is nipped and rewound.

### DETAILED DESCRIPTION

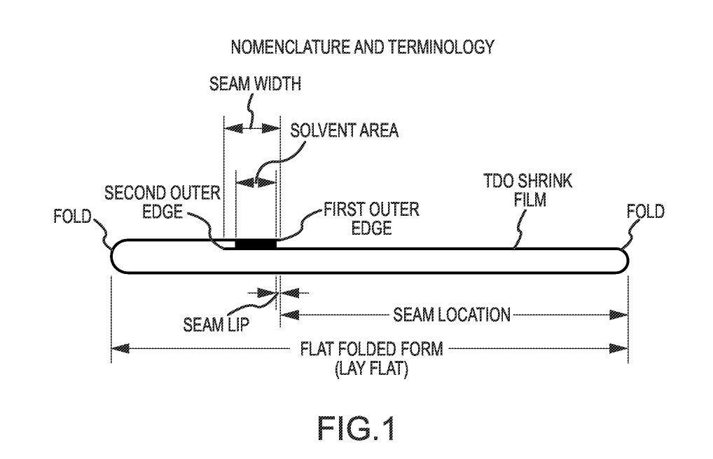

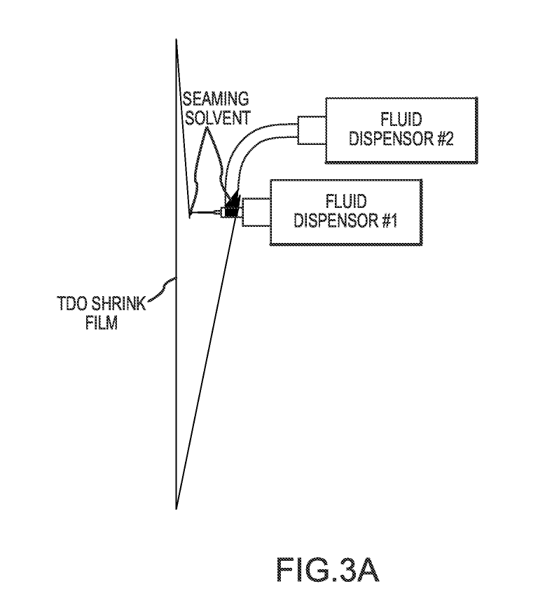

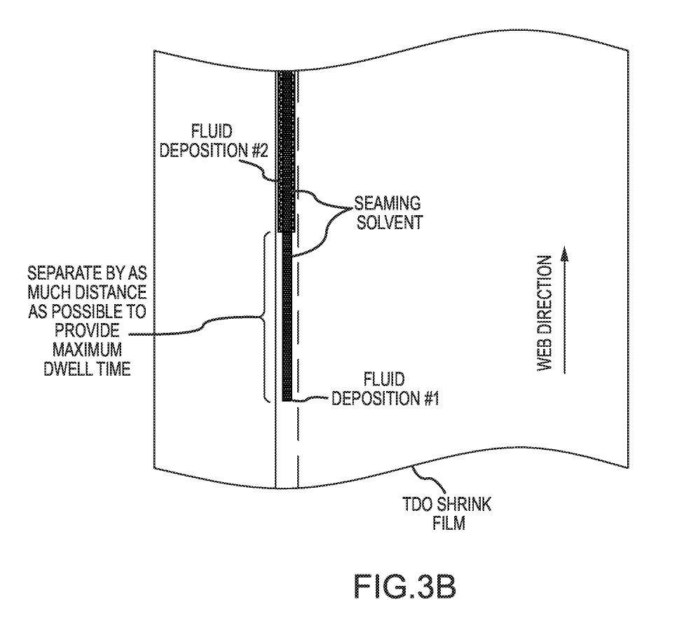

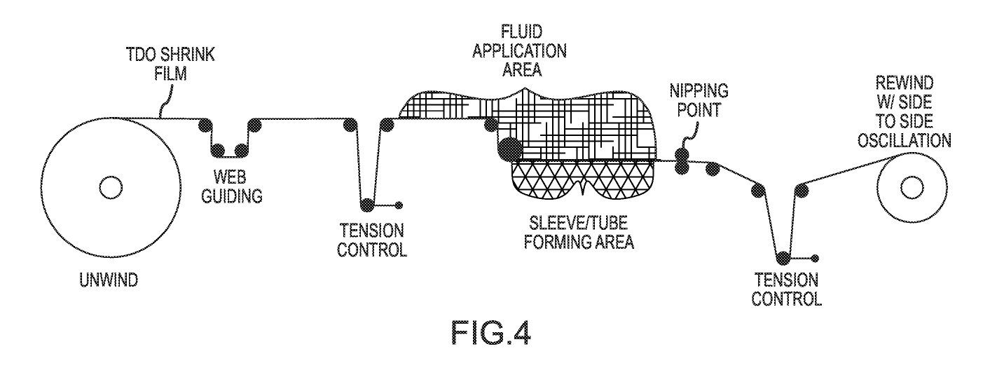

According to some aspects of the invention, there is provided a process for producing a flat-folded form of a transverse direction orientated (TDO) shrink film tube having reduced or eliminated incidences of open (un-bonded) or weak seams. Generally, shrink film sleeves or tubes are prepared from a flat piece of TDO shrink film or continuous web of TDO shrink film from a roll (referred to as the “web” in the industry). FIG. 4 provides an exemplary general overview of the process. Usually the TDO shrink film is supplied either as a flat piece or on big rolls of flat film. The rolls are unwound and the flat shrink film is guided into a seaming machine. Various web guides and tension controls help direct this process to ensure the web is properly positioned before entering the fluid application area. The solvent is deposited in the solvent area and then the film is folded. In another scenario, the flat film can be folded around a forming horn and the seaming solvent is then deposited to the “solvent area” of the film (see FIG. 1 and FIG. 3a) that will eventually become the seam of the formed TDO shrink film sleeve. In either case, after the solvent is deposited, the film proceeds to a nipping point or nipping area where it undergoes nipping. Nipping is the process where the “seam width” (see FIG. 1) receives some sort of physical pressure, such as from rollers, to bond the seam and form a flat form of the TDO shrink film tube. The seam width in the TDO shrink film tube is the only part of the tube that has three layers of shrink film. See FIG. 1. Then the flat form of the shrink film tube film is rewound onto rolls. FIG. 1 also shows the “seam location” which is defined in the industry as the distance from the outer lip edge to the tubing fold facing that edge.

Certain aspects of the invention relate to an improved seaming process that reduces the formation of weak or open (un-bonded) seams. The process may involve at least two independent depositions of solvent from at least two independent solvent fluid dispensers. In certain embodiments, two independent solvent fluid dispensers and two independent depositions of solvent are preferred. Herein throughout the specification, reference will be made to two depositions and two dispensers for easier reading, but this is not meant to be limiting to two. In other embodiments, one fluid dispenser could be configured to have two separate dispenser tips instead of having two fluid dispensers.

In certain embodiments, each of the two independent solvent fluid dispensers has its own independent delivery-train system attached to its own solvent reservoir. In other embodiments, the two independent solvent fluid dispensers share a delivery-train system and a solvent reservoir. In other embodiments, the two independent solvent fluid dispensers have their own delivery-train system but share the same solvent reservoir.

The delivery-train system is the system that connects the fluid reservoir to the fluid dispenser and includes the tubing that connects and delivers the solvent from the fluid reservoir to the fluid dispenser, as well as flow control and pressure regulation devices.

In certain embodiments, the process involves a flat TDO shrink film (having a first and second outer edge). In the manufacture of a tube or sleeve from a flat piece of shrink film, solvent is applied to an area of the flat film, which will eventually become the tube seam. This area of the film where the solvent is applied is referred to herein as the “solvent area.” (See FIG. 1). The width of the solvent area will vary, depending upon the width of the film, and the seam width, for example. The solvent area is preferably narrower than the seam width. The seam width area is where the first and second edges of film will meet—in other words according to FIG. 1, where the bottom side of the first outer edge overlaps the top side of the second outer edge to form a tube. For example, if the seam width is about 4-8 mm, the solvent area might be from about 2 to about 5 mm in width.

In certain embodiments, two (or at least two) independent depositions of solvent are applied to the film in the solvent area in preferably substantially continuous depositions. The two depositions are applied in substantially the same footprint of the solvent area and the applications are substantially superimposed on each other. With this process, if the first deposition of solvent contained less than the preferred amount of solvent or if the first solvent deposition actually skipped a region, since the second solvent deposition is applied to the same footprint and is intended to be superimposed over the area of the first solvent deposition, the second deposition will “fix” the error and thus reduce, and preferably, totally eliminate weak or open seam defects caused by a spotty (non-continuous) or insufficient solvent deposition. In certain embodiments, there is a 51%-99% reduction in weak or open seams. In certain embodiments, there is a 51%-85%, 51%-90%, 51%-95%, 60%-85%, 60%-90%, 60%-95%, 70%-85%, 70%-90%, 70%-95%, 80%-90%, 85%-95%, 90%-95%, or 95%-98% reduction in weak or open seams. In certain embodiments there is a greater than 51%, greater than 55%, greater than 60%, greater than 65%, greater than 70%, greater than75%, greater than 80%, greater than 85%, greater than 90%, greater than 95% or greater than 99% reduction in weak or open seams. In certain embodiments there is a greater than 90%, 91%, 92%, 93%, 94%, 95%, 96%, 97%, 98% or 99% reduction in weak or open seams. In certain embodiments there is a complete reduction (i.e. 100%) in weak or open seams.

In addition to reducing weak or open (un-bonded seams), in certain embodiments, by having at least two depositions of solvent applied in preferably substantially continuous depositions that are substantially the same footprint and substantially superimposed over each other, there is an improved seam lip quality in the TDO shrink film tube. An improved seam lip quality means there is a reduced occurrence of bead formation and/or bead size when the TDO shrink film tube is shrunk onto the container. In formation of the TDO shrink film tube, the goal is to have the solvent deposited as close to the outer edge as possible so as to reduce the size of the seam lip, while at the same time ensuring that the solvent deposition does not go beyond the outer edge (see FIG. 1 showing the seam lip as the area from the first outer edge to the boundary of the solvent deposition). This is because after a TDO shrink film tube is made and then placed and shrunk around the desired container, the seam lip can form undesirable “beads.” When the TDO shrink film tube is shrunk, the entire tube shrinks inwards onto the container. However, the seam lip, because it is not tacked down, like the seam, it shrinks upon itself as a single layer. Because it has nothing to support it, it tends to shrink and form what is called a “bead” in the industry. The bead is an undesirable trait as it is unsightly and unpleasant to the touch as it creates a rough spot or protrusion in an otherwise smooth shrunk TDO shrink film tube.

In embodiments of the invention, because there is at least two (and in certain embodiments two) solvent depositions in the substantially the same footprint (i.e. within the solvent area) and are superimposed over each other, one of the solvent depositions can be shifted ever so slightly more towards the outer edge to reduce the width of the seam lip. Any one of the solvent depositions can be shifted (e.g. the first or second solvent depositions can be shifted).

Reducing the width of the seam lip leads to less beading and/or smaller beads and hence leads to an improved seam lip quality.

In certain embodiments, after the deposition of the solvents, the flat TDO shrink film is folded as routinely practiced in the art. For example, the first and second edges of the flat TDO shrink film are folded to contact the solvent area containing the solvent to form a flat-folded form of a TDO shrink film tube. See FIGS. 1 and 3b. The seaming area is then “nipped” to ensure contact between the seam width area of the film (and the seaming solvent therein). In other embodiments, also as routinely practiced in the art, the flat TDO shrink film is first folded around a forming horn and then the solvent is applied to one or the other side of the seam width and then the seam is nipped. See FIG. 1 and FIG. 3a.

FIG. 3a shows an embodiment of the invention where the TDO shrink film is folded first and the seaming solvent is then applied. FIG. 3a shows an exemplary configuration of two independent fluid dispensers. Fluid dispenser 2 is depicted as a felt tip that can reach around the edge of the film. The figure depicts the felt tip depositing the seaming solvent to the bottom side of one outer edge of the TDO shrink film. Fluid dispenser 1 is depicted as a dispensing needle applying the seaming solvent to the top side of the other outer edge of the TDO shrink film. When these two edges are nipped, the depositions of the first and second seaming solvent will be superimposed on each other and are in substantially the same footprint (in the solvent area).

The two independent fluid dispensers may deposit the same solvent or different solvents. For example, it may be desirable to use a solvent or solvent blend that has a slower evaporation rate in the first fluid dispenser that first deposits the solvent so the solvent does not evaporate or dry before the web is nipped.

The solvent(s) can be any solvent or solvent blends used in the industry. The solvent choice usually depends upon the type of TDO shrink film being seamed. One skilled in the art would understand and appreciate the correct choice of solvent or solvents to be used. A very common seaming solvent is tetra-hydro-furan (THF). Solvent mixtures or blends are commonly used to slow the ambient air evaporation rates or to slow the aggressive attack for solvent bonding, etc.

The fluid dispensers apply the solvents in a substantially continuous deposition in the solvent area (see FIG. 1). In other words, the solvent is deposited in a substantially continuous stream as opposed to a spot or pattern deposition. A continuous deposition with no interruptions along the seam is preferred and is the goal. However, it often occurs that an intended continuous deposition experiences an unintended short or small disruption in the delivery of the seaming solvent. However, with certain embodiments of the present invention, since there is a second fluid dispenser that deposits a second solvent onto the same footprint substantially superimposed over the first solvent, if there was a spot along the seam where there was an interruption in the first solvent deposition, the second solvent deposition will cover this area, and vice versa, and thus reduce the incidence of weak or open seams. Thus, “substantially continuous” includes as close to a continuous stream that is achievable within the equipment and solvent parameters.

“Footprint” as used herein means the solvent area that is to receive the solvent deposition, which is referred to herein as the “solvent area.” The term “substantially the same footprint” as used herein means that both seaming solvents are deposited in the solvent area, as opposed to, for example, carton manufacturing methods involving different footprints, such as depositing glue in a patterned array or a deposition of multiple different “strips” of glue or “spots” to different areas of the carton to be folded. “Substantially the same footprint” means and includes the situation where the first and second solvent deposition are both deposited in the solvent area. In certain embodiments, “substantially the same footprint” means that the first and second solvent deposition occur in the solvent area and are as close as possible to having the same location vis-a-vis to the seam lip (as close as machine, solvent and manufacturing limitations will allow). For example, if the first and second fluid dispensers had the same applicator tip and were applying the same solvent at the same rate, then it would be more likely that they would have very similar depositions and, for example, they would be positioned about the same distance from the seam lip, and have an almost exact footprint. The term “substantially the same footprint” includes the process that is intended to achieve the exact same footprint with the two solvents being exactly superimposed over each other to the extent achievable with the machinery employed. Thus, for example, if the footprint or superimposed deposition area varied by 0.25 to about 1.0 mm or so, and if this was the closest achievable with the machinery, solvents, etc. then this would still fall under “substantially the same footprint.”

“Substantially the same footprint” also includes the situation where the two solvents are deposited in the same solvent area, but the deposition is not exactly the same. For example, it includes the situation where the first and second solvent depositions have differing widths, albeit both still deposited in the solvent area. See for example, FIG. 3b, depicting the first solvent deposition having a narrower deposition than the second solvent deposition that may occur if two different types of fluid dispensers were used. This situation is still “substantially the same footprint” as they are both in the solvent area and there is overlap between the two depositions.

“Substantially the same footprint” also includes the situation where both solvent depositions occur in the solvent area and where both are substantially superimposed over each other, but one solvent deposition is shifted slightly away from the area of the other solvent deposition to be closer to the outer edge (for example in FIG. 1, the first outer edge) to reduce the width of the seam lip and thus improve the resulting seam lip quality in the TDO shrink film tube.

When the TDO shrink film has the solvent applied when film is flat, there is one solvent area on the flat film that will receive both depositions of solvent. FIG. 3b shows a flat piece of film with one solvent area, where the two solvents have been deposited. However, if the TDO shrink film is folded first, then there may be two solvent areas, one on each edge of the film. See FIG. 1 and FIG. 3a. FIG. 3a shows fluid dispenser 2 depositing the seaming solvent to the under-side of one edge, and fluid dispenser 1 depositing the seaming solvent to the upper-side of the other edge. These edges will come together to form the seam width. When the shrink film is nipped the solvent area on each edge is brought into contact with each other so they have substantially the same footprint vis-à-vis the folded form and the two solvent depositions will ultimately be substantially superimposed over each other.

“Substantially superimposed” means that the two depositions will have overlapping regions with each other and that there is more overlap regions compared to regions where no overlap occurs. The term “substantially superimposed” includes the situation where the two solvent depositions, when brought together in the nipping process as seen in FIG. 3a, will “match” each other to the extent achievable with the fluid dispenser, machinery and solvent type employed. It also includes the situation as depicted in FIG. 3b where the solvent is applied to a flat piece of TDO shrink film and where the second deposition covers the area of the first deposition, or vice versa. As seen in FIG. 3b, the deposition streams do not need to be exactly the same or same width to be considered “substantially superimposed” over each other. As shown in FIG. 3b, “substantially superimposed” also includes the situation where one deposition is narrower than the other. “Substantially superimposed” includes the situation where the two depositions are shifted a bit relative to each other so that the edges of the deposition are a little off, but the majority of the deposition of one solvent covers the deposition of the other solvent. For example, as discussed above, to improve the seam lip quality and reduce beading, one solvent deposition is shifted slightly more towards the outer edge so as to reduce the width of the seam lip.

The term “substantially superimposed” also means that the solvent depositions will be superimposed over each other so that they include more area (width-wise) that is superimposed than the area that is not superimposed. For example, the area where the two depositions of solvent are superimposed is greater than the area where the two depositions of solvent are not superimposed. In certain embodiments, the area of width-wise superimposition is at least 50% or in other embodiments greater than 50%, 60%, 70%, 80%, 90%, 91%, 92%, 93%, 94%, 95%, 96%, 98%, or 99%.

The term “substantially superimposed” is used to distinguish the deposition of the two solvents used in embodiments of the invention where there is a substantial area of superimposed depositions as compared to a situation where there are two depositions completely independent of each other, such as depositions placed side-by-side, or depositions placed end-to-end of each other, and where there is no superimposed areas between the two.

In other embodiments of the invention, the at least two fluid depositions are substantially continuous and are deposited in substantially the same footprint but are either not superimposed over each other or are not substantially superimposed over each other. These embodiments, like the other embodiments, provide a reduction in the occurrence of weak or open seams as well as improved seam lip quality.

In certain of these embodiments, the solvent depositions are not substantially superimposed over each other. In other words they are side-by-side in the solvent area (i.e. have substantially the same footprint) and have minimal area where the depositions cover each other. “Not substantially superimposed” means that the solvent depositions have more areas (width-wise) that do not cover each other than areas that cover each other, but still contain some areas where the solvent depositions overlap minimally to some extent. For example, two solvent depositions that have anywhere from about 1% to about 49% of their areas width-wise superimposed over each other falls within the term “not substantially superimposed.”

In certain of these embodiments, the solvent depositions are not superimposed over each other as they occur side-by-side in the solvent area (i.e. have substantially the same footprint) and have no area where the two solvent depositions cover each other. The term “not superimposed” means side-by-side depositions where the solvent deposition traces do not cover each other (width-wise), although they may abut each other (width-wise).

The two independent fluid dispensers are separated by a certain distance relative to each other. The actual distance between the two can vary and is usually dictated by the equipment design. The distance should not be too great as to allow the first solvent to evaporate or dry before the web is nipped. Similarly, the location of the second fluid dispenser should not be located too far from the nipping roller(s) so the solvents would not evaporate and dry before the nipping step occurs.

Having the two fluid dispensers separated by a distance also provides the ability to have the deposition of the two solvents separated by a dwell time. Dwell time is the time between deposition of the first solvent by the first fluid dispenser and that of the deposition by the second solvent by the second fluid dispenser. The length of the dwell time is dependent on the distance the fluid dispensers are separated and the operation speed (the rate that the TDO shrink film is being passed by the fluid dispensers in the fluid application area).

The fluid dispensers can be any type used in the industry, including, but not limited to, a mechanically engraved wheel, flattened metal tubing, a felt tip or a dispensing needle. The choice of type of fluid dispenser would easily be made by one skilled in the art. In certain embodiments the two fluid dispensers are the same and in certain embodiments, they differ from each other. As a non-limiting example, one fluid dispenser may be a felt tip and the other fluid dispenser may be a dispensing needle. In another non-limiting example the first dispenser may be a dispensing needle and the second dispenser may be a felt tip. In this example, the dispensing needle usually deposits a narrower band of solvent than may be achieved with a felt tip. In certain aspects, the felt tip dispenser can reach around the corner of the web whereas the needle dispenser usually requires the web to be opened to gain access to the seaming area (see for example, FIG. 3a).

In some embodiments, there may be more than two independent depositions of solvent. For example, there may be three, four, five or more independent fluid dispensers for depositing three, four, five or depositions of solvent. In these embodiments, the fluid dispensers may have their own independent fluid reservoirs and delivery-trains or they may share with each other. In the case where each fluid dispenser is depositing a different solvent, then the fluid reservoirs will be different from each other.

The process may further involve an observation step to observe the deposition of the solvents. This may be performed with observation device(s) and observation processes known in the art. For example, the solvent can have a specific UV detector or in certain cases, optical brighteners or other colorants can be added to the solvent to aid in observation of its deposition onto the film. The observation device can then relay the information about the deposition of the solvents to a human operator, a controller, or a computer, which can then either directly move and position the fluid dispensers(s) to achieve a more optimal deposition of the solvents in the solvent area or indirectly (e.g. through a controller or a computer) to a fluid dispenser positioning component that can move and position the fluid dispenser(s) as desired.

The observation device can also relay information directly to the solvent reservoir and/or delivery-train, to a controller, to a computer or to a human operator so that output of the solvent flow can be regulated to ensure that the optimal amount of solvent is being applied. For example, if the observation device detects that the deposition of the first solvent appears to be spotty, it can relay a message directly to the solvent reservoir and/or delivery-train to increase the flow of the first solvent. Alternatively, the observation device could relay the message to a human operator, controller, or a computer, which then relays the message to the fluid reservoir and/or delivery train. In another example, if the observation component observes too many errors and/or a complete lack of solvent deposition, it can relay this message to the human operator, controller or computer, which can then shut the seaming machine down for inspection and repair.

In certain embodiments the first and second solvents have a different UV detector, optical brightener, or colorant so as to assist in the observation/detection of deposition errors. The observer(s) can detect areas where one or both solvents are not present and relay this information back to the operator, controller or computer. By using a different UV detector, optical brightener, or colorants, one can know which deposition has failed.

Processes described herein can be used with any TDO shrink film known in the industry. For example, the TDO shrink film can be comprised of oriented poly-styrene (OPS), polyethylene-tere-phthalate (PET), glycol modified polyethylene-tere-phthalate (PETG), poly lactic acid (PLA), polyolefin (PO) or poly-vinyl-chloride (PVC), or the shrink film may be a film structure comprising several co-extruded layers of different polymers.

The TDO shrink film and the resulting TDO shrink film tube/sleeve may be used for any purpose known in the industry, for example, but not limited to, use in full or partial body TDO shrink sleeve labels, tamper evident neck bands, two-in-one (combination of full or partial body TDO shrink sleeve label and tamper evident neck bands), and multi- or combination packs.

Embodiments of the invention include a flat-folded form of TDO shrink film tube formed by processes described herein. The TDO shrink film tube may be supplied as either a continuous roll film or as “cut bands” (individual labels are cut and then stacked). Embodiments of the invention also include a device useful for practicing the processes described herein. The device is designed for applying two independent depositions of solvent (or more such as three, four, five or more), wherein the depositions of solvent are applied so they are superimposed on each other are in substantially the same footprint in the solvent area. The device includes a first and a second solvent fluid dispenser to apply the two independent depositions of solvent. In other embodiments, one fluid dispenser could be configured to have two separate dispenser tips instead of having two fluid dispensers.

The device can be configured so that the two independent fluid dispensers are spaced a certain distance apart so that the solvent deposition of the first and second solvent occur at different positions along the seaming flow path, while maintaining the same footprint and superimposed on each other. For example, but not limited to, the fluid dispensers could be separated so that they are spaced from about 50 mm apart to about 10,000 mm or more, where the minimum and maximum distances are dictated by equipment design limitations. The fluid dispensers could be separated so that they are spaced from about 50 mm to about10,000 mm apart, from about 50 mm to about 9,000 mm apart, from about 50 mm to about 8,000 mm apart, from about 50 mm to about 7,000 mm apart, from about 50 mm to about 6,000 apart, from about 50 mm to about 5,000 apart, from about 50 mm to about 4,000 apart, from about 50 mm to about 3,000 apart, from about 50 mm to about 2,000 mm apart, from about 50 mm to about 1,000 mm apart, or from about 50 mm to about 500 mm apart. This separation of the fluid dispensers allows the deposition of the seaming solvent to be separated by a certain dwell time.

The fluid dispensers can be any type used in the industry, including but not limited to a mechanically engraved wheel, flattened metal tubing, a felt tip and a dispensing needle. The choice of type of fluid dispenser would easily be made by one skilled in the art. In certain embodiments the two fluid dispensers are the same and in certain embodiments, they differ from each other.

The devices may also comprise fluid reservoirs and delivery-train components that deliver solvent from the fluid reservoirs to the fluid dispensers. Each fluid dispenser may be connected to its own fluid reservoir and delivery-train or the fluid dispensers may share fluid reservoirs. For example, if there are two independent fluid dispensers and a different solvent is to be deposited from each fluid dispenser, then it would be necessary to have two different fluid reservoirs and two different delivery-trains.

The device may further comprise an observation component(s), a fluid dispenser positioning component(s), a controller(s) and/or a computer(s). These components would function as describe above with respect to the process descriptions.

1. A process for producing a flat-folded form of a TDO shrink film tube, the process comprising:
a) providing a flat TDO shrink film having a first and second outer edge;
b) applying to the TDO shrink film in a solvent area at least two independent depositions of solvent; wherein the at least two depositions of solvent are deposited in substantially continuous depositions that are substantially superimposed on each other in substantially the same footprint of the solvent area; wherein the at least two independent depositions of solvent are applied from at least two independent fluid dispensers, and delivery-train systems; and
c) folding the first and second edges of the flat TDO shrink film to contact each other and to contact the solvent area containing the solvent deposition and nipping the solvent area to form a flat-folded form of the TDO shrink film tube.

2. A process for producing a flat-folded form of a TDO shrink film tube, the process comprising:
a) providing a flat TDO shrink film having a first and second outer edge, wherein the TDO shrink film is folded around a forming horn;
b) applying to the TDO shrink film in a solvent area at least two independent depositions of solvent; wherein the at least two depositions of solvent are deposited in substantially continuous depositions that are substantially superimposed on each other and are in substantially the same footprint of the solvent area; wherein the at least two independent depositions of solvent are applied from at least two independent fluid dispensers and delivery-train systems; and
c) nipping the solvent area to form a flat-folded form of the TDO shrink film tube.

3. The process of claim 1 where there are two independent fluid dispensers and two independent depositions of solvent.

4. The process of claim 3 wherein there are two different solvent reservoirs and two different delivery-train systems.

5. The process of claim 3 further comprising an observation step where an observation component observes the solvent deposition.

6. The process of claim 5 further comprising a re-position step whereby a fluid dispenser positioning component moves and positions the first and/or second fluid dispensers based on the observation step.

7. The process of claim 3 wherein the two independent depositions of solvent are applied in a substantially continuous stream.

8. The process of claim 3 wherein the two independent depositions of solvent are the same solvent.

9. The process of claim 3 wherein the two independent depositions of solvent are different solvents.

10. The process of claim 9 wherein the two different solvents each have a different UV detector, optical brightener or colorant.

11. The process of claim 3 wherein the two independent fluid dispensers are separated by a distance.

12. The process of claim 11 wherein the two independent fluid dispensers are separated by a distance of about 50 mm to about 10,000 mm apart.

13. The process of claim 3 wherein the two independent solvent depositions are separated by dwell time.

14. The process of claim 3 wherein the TDO shrink film is comprised of oriented poly-styrene (OPS), polyethylene-tere-phthalate (PET), glycol modified polyethylene-tere-phthalate (PETG), poly lactic acid (PLA), polyolefin (PO) or poly-vinyl-chloride (PVC) or is a film structure comprising several co-extruded layers of different polymers.

15. A process for producing a flat-folded form of a TDO shrink film tube that has an improved seam lip quality and reduced beading upon shrinkage of the TDO shrink film tube on a container, the process comprising:
a) providing a flat TDO shrink film having a first and second outer edge;
b) applying to the TDO shrink film in a solvent area at least two independent depositions of solvent; wherein the at least two depositions of solvent are deposited in substantially continuous depositions that are substantially superimposed on each other in substantially the same footprint of the solvent area; wherein the at least two independent depositions of solvent are applied from at least two independent fluid dispensers, and delivery-train systems;
wherein one of the at least two depositions of solvent is shifted towards the outer edge relative to the other depositions of solvents to reduce the width of the seam lip;
c) folding the first and second edges of the flat TDO shrink film to contact each other and to contact the solvent area containing the solvent deposition and nipping the solvent area to form a flat-folded form of the TDO shrink film tube.

16. A process for producing a flat-folded form of a TDO shrink film tube that has an improved seam lip quality and reduced beading upon shrinkage of the TDO shrink film tube on a container, the process comprising:
a) providing a flat TDO shrink film having a first and second outer edge, wherein the TDO shrink film is folded around a forming horn;
b) applying to the TDO shrink film in a solvent area at least two independent depositions of solvent; wherein the at least two depositions of solvent are deposited in substantially continuous depositions that are substantially superimposed on each other and are in substantially the same footprint of the solvent area; wherein the at least two independent depositions of solvent are applied from at least two independent fluid dispensers and delivery-train systems;
wherein one of the at least two depositions of solvent is shifted towards the outer edge relative to the other depositions of solvents to reduce the width of the seam lip; and
c) nipping the solvent area to form a flat-folded form of the TDO shrink film tube.

17. A flat-folded form of a TDO shrink film tube formed by the process of claim 3.

18. The TDO shrink film tube of claim 17, wherein the shrink film tube is used for full or partial body TDO shrink sleeve labels, tamper evident neck bands, two-in-one (combination of full or partial body TDO shrink sleeve label and tamper evident neck bands), and multi- or combination packs.

19. A device for applying two independent depositions of solvent, wherein the two independent depositions of solvent are deposited in substantially continuous depositions that are substantially superimposed on each other and in substantially the same footprint, the device comprising a first and a second fluid dispenser to apply the two independent depositions of solvent.

20. The device of claim 19 further comprising an observation component that observes and monitors the two solvent depositions.

21. The device of claim 20 wherein the two solvents each have a different UV detector, optical brightener or colorant.

22. The device of claim 20 further comprising a fluid dispenser positioning component that moves and positions the first and second fluid dispensers to improve placement of the solvent deposition.

23. The device of claim 22 wherein the fluid dispenser positioning component moves and positions the first and second fluid dispenser based on feedback received from an observation component.

24. A process for producing a flat-folded form of a TDO shrink film tube, the process comprising:
a) providing a flat TDO shrink film having a first and second outer edge;
b) applying to the TDO shrink film in a solvent area at least two independent depositions of solvent; wherein the at least two depositions of solvent are deposited in substantially continuous depositions that are not substantially superimposed on each other in substantially the same footprint of the solvent area; wherein the at least two independent depositions of solvent are applied from at least two independent fluid dispensers, and delivery-train systems; and
c) folding the first and second edges of the flat TDO shrink film to contact each other and to contact the solvent area containing the solvent deposition and nipping the solvent area to form a flat-folded form of the TDO shrink film tube.

25. A process for producing a flat-folded form of a TDO shrink film tube, the process comprising:
a) providing a flat TDO shrink film having a first and second outer edge, wherein the TDO shrink film is folded around a forming horn;
b) applying to the TDO shrink film in a solvent area at least two independent depositions of solvent; wherein the at least two depositions of solvent are deposited in substantially continuous depositions that are not substantially superimposed on each other and are in substantially the same footprint of the solvent area; wherein the at least two independent depositions of solvent are applied from at least two independent fluid dispensers and delivery-train systems; and
c) nipping the solvent area to form a flat-folded form of the TDO shrink film tube.

26. A process for producing a flat-folded form of a TDO shrink film tube, the process comprising:
a) providing a flat TDO shrink film having a first and second outer edge;
b) applying to the TDO shrink film in a solvent area at least two independent depositions of solvent; wherein the at least two depositions of solvent are deposited in substantially continuous depositions that are not superimposed on each other in substantially the same footprint of the solvent area; wherein the at least two independent depositions of solvent are applied from at least two independent fluid dispensers, and delivery-train systems; and
c) folding the first and second edges of the flat TDO shrink film to contact each other and to contact the solvent area containing the solvent deposition and nipping the solvent area to form a flat-folded form of the TDO shrink film tube.

27. A process for producing a flat-folded form of a TDO shrink film tube, the process comprising:
a) providing a flat TDO shrink film having a first and second outer edge, wherein the TDO shrink film is folded around a forming horn;
b) applying to the TDO shrink film in a solvent area at least two independent depositions of solvent; wherein the at least two depositions of solvent are deposited in substantially continuous depositions that are not superimposed on each other and are in substantially the same footprint of the solvent area; wherein the at least two independent depositions of solvent are applied from at least two independent fluid dispensers and delivery-train systems; and
c) nipping the solvent area to form a flat-folded form of the TDO shrink film tube.
